(19) United States
(12) Patent Application Publication
(10) Pub. No.: US 2025/0020152 A1
(43) Pub. Date: Jan. 16, 2025

(54) FASTENING SYSTEM AND METHOD FOR MOUNTING IN A SUBSTRATE

(71) Applicant: EJOT SE & Co. KG, Bad Berleburg (DE)

(72) Inventors: Kostja Heinrich, Bad Berleburg (DE); Michael Pitz, Battenberg (DE); David Ulbrich, Bad Laasphe (DE)

(21) Appl. No.: 18/716,367

(22) PCT Filed: Dec. 1, 2022
(86) PCT No.: PCT/EP2022/084052

§ 371 Date: Jun. 4, 2024

(30) Foreign Application Priority Data
Dec. 9, 2021 (DE) 10 2021 214 068.8

(51) Int. Cl. F16B 19/02

(52) U.S. Cl. CPC F16B 19/02

(57) ABSTRACT

A fastening system for mounting on a substrate is described. The fastening system comprises a sleeve and an inner element, wherein the sleeve comprises a holding portion, a spreading zone and a drill opening at one of the two ends of the sleeve and a tool opening at the other end, wherein the spreading zone is arranged at least partially between the holding portion and the drill opening, and wherein the inner element is arranged at least partially within the sleeve and is movable relative to the sleeve, and wherein the inner element comprises a drilling portion and an spreading portion, wherein the drilling portion comprises at least one cutting element and the drilling portion projects at least partially out of the drill opening of the sleeve and the spreading portion of the inner element is adapted to expand the spreading zone of the sleeve during a movement of the spreading portion in the sleeve and relative to the sleeve in the direction from the tool opening to the drill opening. Further, a corresponding mounting method and a production method are described.

The present invention generally relates to a fastening system and a method for mounting at a substrate. Furthermore, the invention also relates to a method for producing a fastening system according to the invention.

Numerous systems for mounting at a substrate are known in the art which make it possible to fasten objects relative to the substrate. These known systems have in common that they are anchored in the substrate in a multi-step method. Thus, for example, systems comprising a dowel sleeve and a fastening element are known in which firstly a blind hole is produced in the substrate for receiving the dowel sleeve. After the dowel sleeve has been introduced into the blind hole, the fastening element is screwed into the dowel sleeve and is anchored typically by deformation of the dowel sleeve. Known systems of this type can be used, for example, for fastening insulating materials relative to a substrate or for fastening heavy loads to a substrate.

However, the known systems have the disadvantage that the mounting process consists of multiple steps. Usually, at least three steps are required in order to anchor the system in the substrate, namely firstly the production of a blind hole, secondly the placement of a dowel sleeve in the blind hole and thirdly the relative movement between a fastening element and the dowel sleeve for deforming the dowel sleeve and thereby producing a force-fitting connection between the substrate and the fastening system. While the production of the blind hole is typically the same for the known systems, the two other steps can be different for each system. For example, in the case of a system for fastening an insulating material to a substrate, firstly only a dowel sleeve can be inserted into the blind hole and subsequently a fastening element can be introduced into the dowel sleeve, wherein the fastening element deforms at least a portion of the dowel sleeve in order to produce a sufficient anchoring effect in the substrate. In this case, the load-bearing capacity is produced by the friction of the deformed portion of the sleeve on the walls of the blind hole. On the other hand, in the case of a typical heavy load anchor, a system comprising a dowel sleeve and a fastening element arranged in the dowel sleeve is inserted into the blind hole. Subsequently, the fastening element is rotated relative to the dowel sleeve in order to pull it partially out of the dowel sleeve, wherein the relative movement spreads a portion of the dowel sleeve in order to produce an undercut which provides the load-bearing capacity. Even if the explicit steps of the known mounting processes are different or can be varied, the known mounting processes in each case require multiple steps which are clearly separate from one another.

In addition, known mounting processes typically require multiple tools, namely firstly one tool for producing the blind hole and secondly at least one other tool for the relative movement of the fastening element and the dowel sleeve. In the case of the abovementioned system for fastening insulating materials, a drilling machine for producing the blind hole and, for example, a screwdriver for introducing the fastening element into the dowel sleeve are usually used, whereas in the case of the abovementioned system for fastening heavy loads, a drilling machine for producing the blind hole is likewise used and, in addition, a wrench or socket spanner is used. In addition, in some cases, additional tools for removing drilling dust which accumulates during the production of the blind hole may also be necessary.

The object of the present invention is to overcome the abovementioned disadvantages and to provide a system which simplifies the mounting process.

This object is achieved by a fastening system according to the invention, a method according to the invention for mounting a fastening system and a method according to the invention for producing a fastening system, as are described in the respective independent claims. Preferred and advantageous embodiments are found in the dependent claims and in the following description.

The fastening system according to the invention is configured for mounting at a substrate. The substrate may be an anchoring substrate or a multilayer substrate, for example comprising one or more insulating materials and an anchoring substrate. The fastening system according to the invention has a sleeve and an inner element. In this case, the sleeve has a holding portion and a spreading zone. Furthermore, the sleeve has a drill opening at a first of its two ends and a tool opening at the other end. During the mounting process, the holding portion opposes a further penetration of the sleeve into the substrate at a specific point during mounting. Within the scope of the present invention, there are various possibilities as to how the holding portion can be configured. For example, the holding portion can be realized as a projection formed circumferentially at the first end. With respect to further preferred embodiments, further possibilities as to how the holding portion can be configured are indicated later on. The spreading zone is arranged at least partially between the holding portion and the drill opening. The sleeve can be formed substantially by a hollow cylinder, wherein the drill opening and the tool opening are then located, for example, on the top or on the base of the hollow cylinder.

During mounting, the inner element is arranged at least partially within the sleeve and is movable relative to the sleeve. A corresponding arrangement of the inner element at least partially within the sleeve can preferably already take place during production, or alternatively only take place immediately before mounting. Furthermore, the inner element has a drilling portion and a spreading portion. The drilling portion has at least one cutting element. The at least one cutting element is suitable for cutting into the substrate during use of the fastening system. The drilling portion projects at least partially out of the drill opening of the sleeve. This means that at least a portion of the drilling portion is located outside the sleeve. In this case, for example, the entire drilling portion or a portion of the drilling portion can be located outside the sleeve in order to enable contact between the drilling portion and the substrate during the mounting process. As will be appreciated by a person skilled in the art, the term “drilling portion” is not to be understood to mean that the drilling portion is exclusively restricted to drilling processes. Rather, the drilling portion can also be configured to enable chiseling. For example, the at least one cutting element of the drilling portion can be adapted for cutting into a substrate or the at least one cutting element can be adapted for chiseling into a hard substrate.

During a movement of the spreading portion in the sleeve and relative to the sleeve in the direction from the tool opening to the drill opening, i.e. during mounting further in the direction of the substrate, the spreading portion of the inner element is adapted to spread the spreading zone of the sleeve. This means that the inner element moves relative to the sleeve during the mounting process and, as a result of this movement, the spreading portion, which is located at least partially within the sleeve, is moved in a direction from the tool opening to the drill opening. As a result, the spreading portion exerts a force on the spreading zone of the sleeve. This force can cause the sleeve to be carried along with the movement of the inner element. Furthermore, the spreading portion can cause the spreading zone to be spread by the spreading portion when a minimum force is exceeded. Since the holding portion opposes a further penetration of the sleeve into the substrate, the holding portion can be formed as a setting depth limiter.

The advantage provided by the described fastening system over the prior art is that the fastening system can be mounted at a substrate in a single step. For this purpose, the at least one cutting element of the inner element can be introduced into the substrate (for example by setting the inner element and thus the at least one cutting element in rotation) and thereby produce a blind hole in the substrate. In this case, the inner element carries along the sleeve, as a result of which the sleeve is drawn into the blind hole by the movement of the inner element. The sleeve is carried along with the movement of the inner element until the holding portion of the sleeve prevents further penetration into the substrate. In this case, the holding portion prevents further penetration of the sleeve into the substrate by opposing a force to the further penetration. Within the scope of the present invention, the holding portion can be configured in a wide variety of ways. One possibility is that the holding portion has a projection which prevents penetration of the holding portion into the substrate. Other embodiments are also possible and examples of other embodiments of this type are described further below. The force which the holding portion opposes the further penetration of the sleeve into the substrate is directed counter to the propulsion and prevents further carrying along of the sleeve with the movement of the inner element and thus the further penetration of the sleeve into the substrate. This results in a relative movement between the inner element and the sleeve. As a result of this relative movement, the spreading portion of the inner element spreads the spreading zone of the sleeve and thus produces a force-fitting anchoring of the sleeve in the substrate.

Thus, the production of a blind hole in the substrate, the introduction of the sleeve into the substrate and the spreading of the spreading zone of the sleeve (i.e. the anchoring) all take place in one working step by the propulsion of the inner element into the substrate. Furthermore, for the complete mounting process of the fastening element in the substrate, only a single setting tool is required which is suitable for driving the at least one cutting element of the inner element, for example by rotation and/or impact, and thereby producing a propulsion of the inner element into the substrate. Therefore, not only is the method for mounting a fastening system simplified, but at the same time the number of tools to be used is reduced.

Preferred embodiments of the fastening system according to the invention are described below.

In the unspread state, the spreading zone of the sleeve has a first outer diameter and the drilling portion of the inner element has a maximum second outer diameter. In a preferred embodiment, the drilling portion is substantially pointed at its frontmost end, which first strikes the substrate, and widens in the direction of its rear end. As a result, the outer diameter of the drilling portion changes depending on the distance from the tip. Furthermore, the at least one cutting element of the drilling portion can be configured as one or more projections formed on the circumferential surface of the drilling portion, which do not necessarily extend over the entire circumference. Therefore, below it is referred to a maximum outer diameter of the drilling portion. In a preferred embodiment, this is the diameter of the largest circumferential circle of the drilling portion. For delimitation from the outer diameter of the spreading zone of the sleeve, this maximum diameter of the drilling portion is referred to as maximum second outer diameter. This maximum second outer diameter of the drilling portion defines the inner diameter of the blind hole. Preferably, the maximum second outer diameter is equal to the first outer diameter, i.e. the outer diameter of the unspread spreading portion of the sleeve, or larger than the first outer diameter of the sleeve. This allows low-resistance sliding of the sleeve into the blind hole during the mounting process until the holding portion prevents further penetration.

A person skilled in the art will understand that equality of the diameters in this context means that the diameters can be substantially equal. Substantially equal in this context means that certain processing tolerances are permitted. It is relevant that, on the one hand, the first and the second outer diameters are matched to one another in such a way that they allow penetration of the sleeve into the blind hole—in particular by being carried along with the movement of the inner element—but, on the other hand, also allow the spreading of the spreading zone of the sleeve to provide sufficiently strong anchoring of the sleeve in the blind hole.

In a further preferred embodiment, the spreading portion of the inner element is configured in such a way that the spreading portion can rotate freely within the sleeve, such that rotation of the inner element does not necessarily lead to rotation of the sleeve. As a result, the inner element can be driven in order to produce a blind hole in the substrate without the ability of the inner element to carry along the sleeve during propulsion into the substrate being impaired. This can be achieved, for example, by a conical configuration of the spreading portion. However, this can also be achieved by virtue of the cross sections of the spreading portion and of the interior of the sleeve not having a complementary geometry. Furthermore, the conical configuration allows the spreading portion to strike the spreading zone during propulsion of the inner element and successive spreading of the spreading zone during further propulsion of the inner element. However, in other preferred embodiments, the spreading portion can also be of stepped configuration, wherein the steps have a larger outer diameter with increasing distance from the drilling portion. However, in yet other preferred embodiments, the spreading portion can also be configured as a thread or as a knurling.

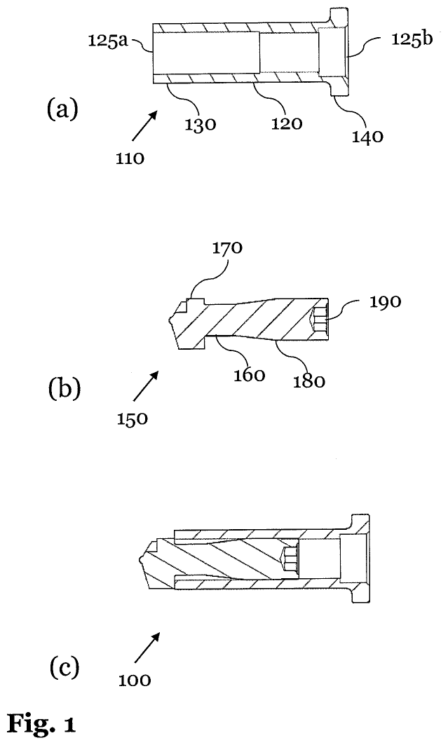

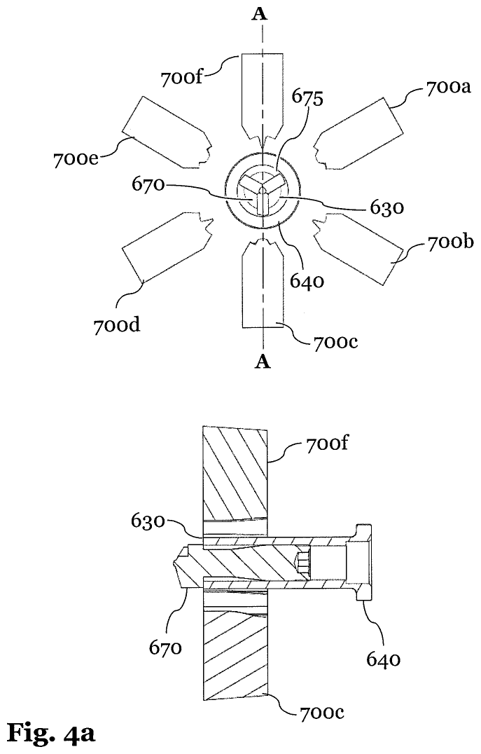

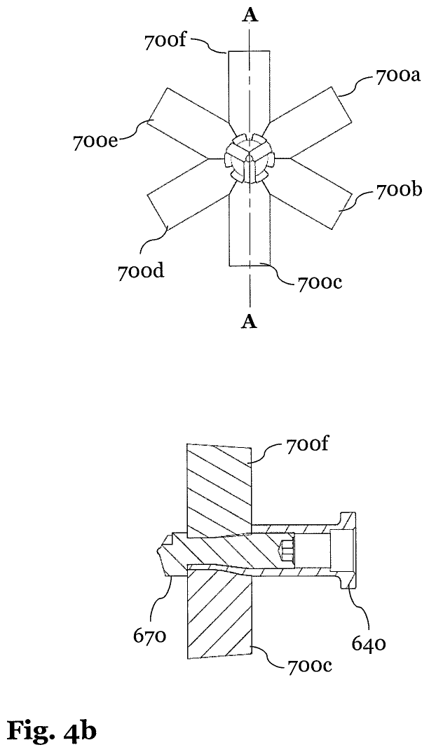

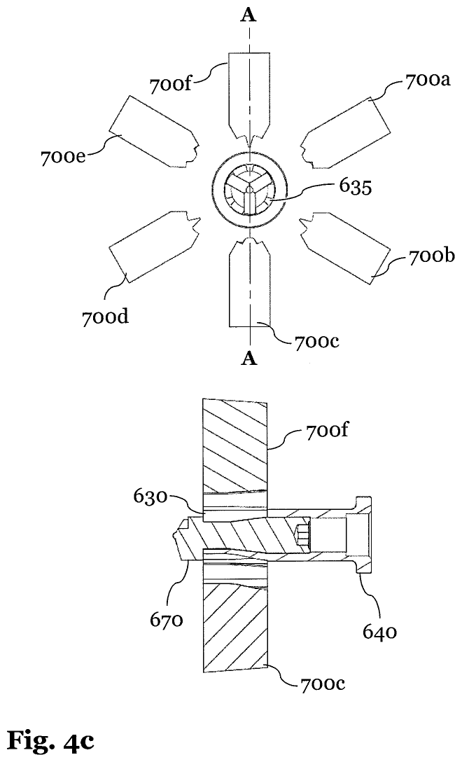

Consequently, the inner element preferably has a shape with different outer diameters. In this case, the drilling portion has the largest outer diameter. The spreading portion has an outer diameter which is different depending on the distance from the drilling portion. Preferably, the outer diameter of the spreading portion is greatest at the point which is furthest away from the drilling portion. However, this largest, i.e. maximum, outer diameter of the spreading portion is preferably smaller than the outer diameter of the drilling portion. Between the drilling portion and the spreading portion, the diameter of the inner element is smaller than the outer diameter of the drilling portion and the maximum outer diameter of the spreading portion. This results in a type of notch, which can also be referred to as a depression, between the drilling portion and the spreading portion. The depression allows the spreading zone of the unspread sleeve to clasp the inner element in the region of the depression. This becomes apparent with reference to the attached drawings, in particular FIGS. 1 and 4.

In a further preferred embodiment, the at least one cutting element can be configured as a cutting edge. Furthermore, in a preferred embodiment, the drilling portion can have a plurality of cutting elements, which are each configured as cutting edges. Preferably, these plurality of cutting edges are arranged on the surface of the drilling portion in such a way that they extend radially outward along the surface from the center of the surface (i.e. the tip of the drilling portion). Preferably, three cutting elements are provided, which are configured as cutting edges. Further preferably, the three cutting edges have an angle of 120° to one another.

In a further preferred embodiment, the inner element can be formed at least partially from a metal. For example, the at least partial formation of the drilling portion—in particular of the at least one cutting element—from a metal can enable propulsion in hard substrates such as concrete or masonry. The drilling portion or at least the at least one cutting element can be produced, for example, from hardened steel. Alternatively, the at least one cutting element can also be formed by applying sintered material to a drilling portion produced from stainless steel.

Alternatively or additionally, the sleeve can be formed at least partially from a metal. Formation of the sleeve from a metal can be recommended, for example, for heavy load anchors in which spreading of a metallic spreading zone of the sleeve produces an undercut in the substrate and thus provides a particularly high pull-out force. A suitable metal would be steel, for example. However, it is also possible to produce at least the sleeve from a plastic, which can be recommended, for example, for a fastening system for fastening insulating materials in order to avoid thermal bridges.

In further preferred embodiments, the sleeve and/or the inner element are configured in such a way as to allow removal of drilling dust which accumulates during mounting. Removal of drilling dust can be made possible, for example, in that one or more additional openings are provided in the sleeve and/or the inner element or a channel is formed, for example, between the sleeve and the inner element.

For example, openings can be provided laterally in the sleeve, through which drilling dust which accumulates can pass into the interior of the sleeve during the mounting process. Preferably, the drilling dust can be removed from the fastening system from here, for example via a suction device of a setting tool or by forces during the mounting process which arise as a result of the fastening system being driven into the substrate. Alternatively or additionally, one or more additional openings can be formed on the drilling portion of the inner element. In this case too, a setting tool with a suction device can be used which interacts with said one or more additional openings in order to remove the drilling dust.

The channel can be formed within the sleeve. In another preferred embodiment, the channel can be formed on an outer side of the sleeve. Alternatively, the channel for removal of drilling dust can also be formed within the inner element. If the channel is formed within the inner element, the setting tool which is used for driving the inner element can have a corresponding channel which, when the setting tool engages the inner element, is connected to the channel in the interior of the inner element. This enables, for example, the suction of drilling dust if the setting tool is equipped with a suction device.

In the case of one or more additional openings or a channel, the drilling portion of the inner element can preferably be configured such that the drilling portion forms a suction drill to which a suction device of a setting tool can be connected. Particularly preferably, the inner element has a receptacle which is connected to at least one of the additional openings or the channel, for example in that a path is formed through which the drilling dust can pass through the inner element. Preferably, the setting tool is configured such that it is adapted to be able to engage the receptacle and to be able to establish a connection between a suction device of the setting tool and the path formed in the inner element.

One or more additional openings or a channel for removal of drilling dust provide the advantage that the drilling dust cannot accumulate in the region of the drilling portion and prevent advancement of the inner element and/or the sleeve. During propulsion of the inner element, the drilling dust can pass into the interior of the sleeve or into the channel and can be removed from there.

The holding portion is adapted to prevent further penetration of the sleeve into the substrate by opposing a force to the further penetration of the sleeve into the substrate. Thus, during further driving of the inner element into the substrate, the holding portion causes the spreading zone to spread. Within the scope of the present invention, several examples of the configuration of a holding portion of this type are described. However, a person skilled in the art will appreciate that this function can also be realized by other means. For example, the holding portion can be configured circumferentially as a projection on the sleeve. However, in a preferred embodiment, the holding portion of the sleeve can also be configured as a holding plate. A holding plate can form a flat ring, an annular projection or an annular disk which is arranged circumferentially on the sleeve. Preferably, the holding plate can be arranged on the end of the sleeve which comprises the tool opening. A holding plate of this type is particularly suitable for use with a multilayer substrate which comprises, for example, an anchoring substrate and an insulating material. In this case, the holding plate can be used for fastening the insulating material to the anchoring substrate. A person skilled in the art will understand that an additional component, such as a sealing sheet resting on the insulating material, can also be held relative to the substrate by the holding plate.

In a further preferred embodiment, the sleeve can also comprise, in addition to a first holding portion, a further holding portion which is configured as a holding plate. In this case, the further holding portion configured as a holding plate is used only to hold an insulating material relative to the substrate, while the first holding portion applies the force at a specific point during mounting in order to prevent further penetration of the sleeve into the substrate and thus leads to the spreading zone being spread. In this case, the first holding portion is preferably placed between the drill opening and the holding plate.

In a further preferred embodiment, the inner element may comprise a receptacle for a setting tool. Preferably, a setting tool may be introduced through the tool opening into the interior of the sleeve and may engage the receptacle on the inner element there. An embodiment of this type has the advantage that the inner element can be driven directly by the setting tool in order to produce a propulsion in the substrate. Alternatively, the inner element can also be configured in such a way that it has a leadthrough in order to enable engagement of the setting tool directly with a receptacle arranged at the drilling portion. For example, the inner element may be formed to be hollow at least in portions or may comprise guide rails for the setting tool.

In a further preferred embodiment, the inner element and the sleeve can be connected in the unspread state via a predetermined separation point. If the sleeve and the inner element are produced from metal, a thin weld seam can be attached, for example, in the region of the spreading zone between the inner element and the sleeve. In the case of a sleeve produced from plastic, a predetermined separation point may be injected, for example, between the inner element and the sleeve. A predetermined separation point provides the advantage that early spreading of the spreading zone, which may be possible, for example, in the case of hard substrates as a result of strong vibrations of the setting tool, is prevented.

The above-described embodiments of the fastening element are not exclusive, but may be combined, as a result of which their technical effects may be combined and interact.

Furthermore, the present object is also achieved by a method according to the invention for mounting a fastening system at a substrate. The method according to the invention is suitable for anchoring a fastening system in a substrate, wherein the fastening system comprises a sleeve and an inner element. Furthermore, the sleeve comprises a holding portion, a spreading zone and a drill opening at one of the two ends of the sleeve and a tool opening at the other end, wherein the spreading zone is arranged at least partially between the holding portion and the drill opening. The inner element is arranged at least partially within the sleeve and is movable relative to the sleeve. The inner element has a drilling portion and a spreading portion, wherein the drilling portion has at least one cutting element and the drilling portion projects at least partially out of the drill opening of the sleeve.

The method comprises driving in the at least one cutting element of the inner element and simultaneously carrying along the sleeve with the movement of the inner element until the holding portion of the sleeve opposes a further carrying along of the sleeve and further driving in the inner element into the substrate, as a result of which a relative movement is produced between the inner element and the sleeve, and simultaneously spreading the spreading zone of the sleeve with the spreading portion of the inner element by the relative movement.

The fastening system used in the method according to the invention for mounting may be one of the above-described fastening systems. Should a fastening system be used for mounting an insulating material, it is understood that the substrate comprises both an anchoring substrate and the insulating material, such that the fastening system is firstly driven into the insulating material and subsequently into the anchoring substrate.

Furthermore, the present object is also achieved by a method according to the invention for producing a fastening system for mounting on a substrate. The method according to the invention comprises providing a plurality of embossing and/or punching tools and providing a sleeve blank, wherein the sleeve blank has a substantially cylindrical shape, and providing an inner element, wherein the inner element has a drilling portion and a spreading portion and wherein the drilling portion has at least one cutting element arranged thereon. A portion of the inner element is placed in the sleeve blank and at least a portion of the sleeve blank is pressed circumferentially onto the portion of the inner element and as a result a spreading zone is formed in the pressed portion. The portion of the inner element which is placed in the sleeve blank comprises at least a portion of the spreading portion. The person skilled in the art will understand that the fastening system, in addition to being pressed by means of embossing and/or punching tools, can also be formed by rolling, without departing from the teaching of the present invention.

The substantial advantage provided by the production method according to the invention is the relative arrangement of a sleeve and an inner element, wherein the drilling portion can be arranged at least partially outside the sleeve and the spreading portion of the inner element is arranged at least partially within the sleeve.

In a preferred embodiment of the production method according to the invention, the spreading portion of the inner element is conically shaped and the circumferential pressing of the portion of the sleeve blank takes place on the conically shaped spreading portion of the inner element.

In a further preferred embodiment, the circumferential pressing of a portion of the sleeve blank further comprises producing at least one predetermined separation point in the spreading zone formed by the pressing. Spreading of the spreading zone may then be possible, for example, by separating the predetermined separation point. Advantageously, the formation of the predetermined separation point takes place directly during formation of the spreading zone by the embossing or punching tools which form the spreading zone on the inner element, so that the fastening system can be produced in as few steps as possible. Furthermore, a plurality of predetermined separation points are preferably formed by the circumferential pressing, in a preferred example three predetermined separation points. Preferably, the plurality of predetermined separation points are located circumferentially around the entire circumference of the sleeve, preferably in a symmetrical manner. In the case of three predetermined separation points, one predetermined separation point can be located after one third of the circumference.

The above-described embodiments of the method for producing the fastening element are not exclusive, but may be combined, as a result of which their technical effects may be combined and interact.

The attached drawings illustrate the fastening system according to the invention and also the mounting method according to the invention and the production method according to the invention on the basis of exemplary embodiments in comparison with the prior art. In the drawings:

FIG. 1 a, b, c show cross sections of a fastening system according to the invention in accordance with an exemplary embodiment, wherein (a) shows a sleeve according to the invention, (b) shows an inner element according to the invention and (c) shows an assembled fastening system,

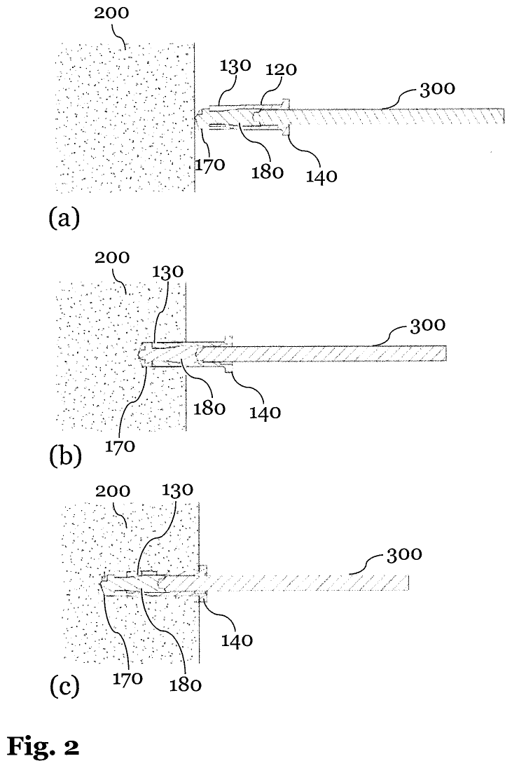

FIG. 2 shows an illustration of a mounting process of a fastening system in accordance with the embodiment from FIG. 1, wherein (a) shows a starting position of a fastening system in front of a substrate, (b) the production of a blind hole in the substrate and simultaneous advancement of the fastening system and (c) the spreading of the spreading zone of the sleeve of the fastening system by further advancement of the fastening system,

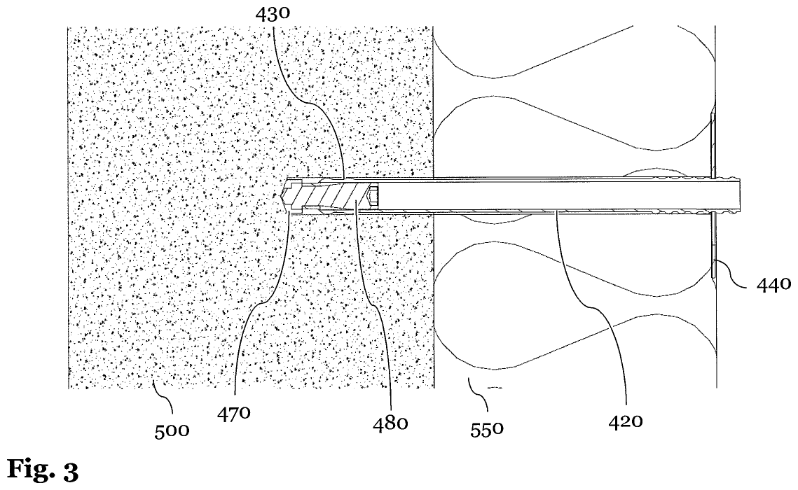

FIG. 3 shows a cross section of a fastening system according to the invention in accordance with another exemplary embodiment with a holding plate for an insulating material panel,

FIG. 4 a, b, c show a schematic illustration of a production method of a fastening system according to the invention, wherein (a) shows an initial state at the start of the production method with embossing and/or punching tools in an initial position, (b) shows an intermediate step during the production method with embossing and/or punching tools in a state pressed into a sleeve blank and (c) shows the termination of the production method in which the embossing and/or punching tools have returned to the initial position again. In each case a plan view and a cross-sectional view are shown in all three constituent parts of the drawing.

FIG. 1 shows cross sections of a fastening system 100 according to the invention in accordance with an exemplary embodiment. The fastening system 100 according to the invention comprises a sleeve 110 and an inner element 150. The sleeve 110 is shown by way of example in FIG. 1 (a). The sleeve 110 forms a hollow cylinder 120 and has two open ends 125a, 125b, wherein one end 125a is referred to as a drill opening and the other end 125b is referred to as a tool opening. In the embodiment shown here, the drill opening is located at the end 125a (first end). Furthermore, the sleeve comprises a spreading zone 130 at the first end 125a. The sleeve comprises a holding portion 140 at the end 125b at which the tool opening is located (second end). In the embodiment from FIG. 1 (a), the holding portion 140 is formed as a projection running circumferentially at the second end 125b of the sleeve. The projection is suitable for resting on a substrate. The spreading zone 130 of the sleeve 110 comprises a plurality of predetermined separation points (not illustrated graphically) which separate when the spreading zone 130 is spread and allow the spreading zone 130 to be spread.

FIG. 1 (b) shows an inner element 150 of the fastening system 100 according to the invention. The inner element 150 comprises a spreading portion 180 and a drilling portion 170. In the embodiment shown in FIG. 1 (b), the spreading portion 180 is conical. The drawing shows a preferred embodiment in which the drilling portion 170 has a larger diameter than the spreading portion 180. In addition, the portion 160 between the drilling portion 170 and the spreading portion 180 comprises a diameter which is smaller than both the outer diameter of the drilling portion 170 and the maximum outer diameter of the spreading portion 180. This makes it possible for the spreading zone 130 to be pressed, for example, onto the portion 160 between the drilling portion 170 and the spreading portion 180 during the production of the fastening system 100. In other words, the portion 160 between the drilling portion 170 and the spreading portion 180 forms a depression 160 and the unspread spreading zone 130 of the sleeve 110 can engage the depression 160.

FIG. 1 (c) shows the fastening system 100 according to the invention consisting of the sleeve 110 of FIG. 1 (a) and the inner element 150 of FIG. 1 (b) located at least partially within the sleeve 110. It can be seen that the maximum outer diameter of the drilling portion 170 of the inner element 150, i.e. the diameter which determines the inner diameter of the blind hole, is substantially equal to the outer diameter of the sleeve 110 (without taking into account the holding portion). This makes it possible for the spreading portion 180 of the inner element to be able to carry along the sleeve 110 during propulsion into the substrate and for the sleeve 110 to slide into the blind hole until the holding portion 140 of the sleeve 110 meets the substrate. Further propulsion of the inner element 150 into the substrate then leads to a relative movement between the inner element 150 and the sleeve 110 and thus to spreading of the spreading zone 130 by the spreading portion 180 of the inner element 150.

FIG. 2 shows an illustration of a mounting process of a fastening system 100 in accordance with the embodiment from FIG. 1. In this case, (a) shows an initial position of a fastening system 100 which is located in front of a substrate 200. This means that FIG. 1 (a) shows the state before the start of the mounting process when providing the fastening system 100.

A blind hole is produced by penetration of the drilling portion into the substrate, which is shown in FIG. 3 (b). At the same time as producing the blind hole, the inner element 150 undergoes a propulsion into the blind hole which is formed. It is clear to a person skilled in the art that either the inner element is already located in a position in which the spreading portion 180 of the inner element 150 meets the spreading zone 130 of the sleeve 110 and the sleeve 110 is immediately carried along with a movement of the inner element 150 into the substrate, or the inner element is located in a different position, so that the inner element 150 initially moves relative to the sleeve 110 until the spreading portion 180 of the inner element 150 meets the spreading zone 130 of the sleeve 110. The spreading zone 130 serves as a barrier for the spreading portion 180 and prevents further relative movement. As a result, the sleeve 110 is carried along by the impact of the spreading portion 180 of the inner element 150 on the spreading zone 130 of the sleeve when the inner element 150 undergoes further propulsion into the substrate 200.

As soon as the sleeve 110 has been carried along with the inner element 150 to such an extent that the holding portion 140 meets the substrate 200 and rests thereon, this resting opposes a further carrying along of the sleeve 110 with the inner element 150, which leads to the sleeve 110 not moving further into the blind hole. If the inner element 150 undergoes a propulsion which is sufficiently large as a result of the driving of the drilling portion 170 into the substrate, the inner element 150 begins to move again relative to the sleeve 110, wherein the spreading portion 180 successively penetrates into the spreading zone 130 and thus spreads the spreading zone 130. As a result of the spreading, material of the spreading zone 130 of the sleeve 110 is forced outward against the walls of the blind hole in the substrate. This displacement of the spreading zone 130 of the sleeve 110 leads to friction between the spread spreading zone 130 of the sleeve 110 and the walls of the blind hole, as a result of which a sufficiently high anchoring force of the fastening system 100 in the substrate 200 is produced. During the displacement of the material of the spreading zone 130 of the sleeve 110, an undercut can be produced, for example, which further increases the anchoring force. This is particularly preferred if the spreading zone 130 of the sleeve 110 is produced at least partially from metal. In another embodiment, the displacement of the spreading zone 130 of the sleeve 110 can be achieved by squeezing the spreading zone 130 against the walls of the blind hole. This is particularly preferred if the spreading zone 130 of the sleeve 110 is produced from plastic.

FIG. 3 shows a cross section of a fastening system according to the invention in accordance with another exemplary embodiment with a holding plate for an insulating material panel. In this case, the substrate comprises an anchoring substrate 500 and an insulating material panel 550.

The fastening system in FIG. 3 comprises a sleeve which has a substantially cylindrical element 420. Located at a front end of the cylindrical element 420 is a spreading zone 430 and a drill opening through which an inner element of the fastening system partially projects. While a spreading portion 480 of the inner element is located within the cylindrical element 420 of the sleeve, a drilling portion 470 of the inner element is located outside the drill opening of the sleeve. At a rear end, the cylindrical portion 420 comprises a holding portion configured as a holding plate 440. This holding plate 440 is adapted to fasten an insulating material panel 550 to the anchoring substrate 500 when the fastening system shown in FIG. 3 is mounted.

The functioning of the fastening system from FIG. 3 is similar to the fastening system from FIG. 1. However, the holding portion is configured as a holding plate 440 for an insulating material panel. As soon as the holding plate meets the insulating material panel of the substrate, the resting of the holding plate on the insulating material panel opposes a further penetration of the sleeve into the substrate, which leads to the spreading portion of the inner element leading to spreading of the spreading zone during further propulsion of the inner element into the substrate.

FIG. 4 shows an illustration of a production method of a fastening process according to the invention. FIG. 4 (a) shows exemplary embossing and punching tools 700a-f which are suitable for pressing a sleeve blank circumferentially and thereby producing a spreading zone 630 in the pressed portion of the sleeve. The person skilled in the art will understand that the embossing and/or punching tools 700a-f, during circumferential pressing of the sleeve, on the one hand can press the outer wall of the sleeve into the interior of the sleeve and on the other hand can cut into the outer walls. For example, one or more predetermined separation points 635 can be produced by the cutting.

FIG. 4 (a) shows in the upper part of the drawing a plan view of the embossing and/or punching tools 700a-f which are arranged in a circle around a sleeve blank with an inserted inner element. In this view, three cutting elements 675 of the drilling portion 670 of the inner element as well as the spreading zone 630 in the blank state and the holding portion 640 can be seen. A cross section along the line A-A in the upper part of the drawing is shown in the lower part of the drawing. In the cross section, it is illustrated how the embossing and/or punching tools can engage in the front portion of the sleeve (i.e. at the end which comprises the drill opening) in order to form a spreading zone 630. In FIG. 4 (a), the embossing and/or punching tools 700a-f are in the initial position.

FIG. 4 (b) shows the state during the production method in which the embossing and/or punching tools 700a-f are pressed onto the front portion of the sleeve blank in order to form the spreading zone. Again, the upper part of the drawing shows a plan view and the lower part shows a cross section along the line A-A.

FIG. 4 (c) shows the state at the end of the production method, i.e. after the embossing and/or punching tools 700a-f have pressed the front portion of the sleeve blank in order to form the spreading zone 630. Now, the embossing and/or punching tools 700a-f are again in the initial position. It can be seen in FIG. 4 (c) that the embossing and/or punching tools 700a-f have formed predetermined separation points 635 in the region of the spreading zone 630. At the predetermined separation points 635, the embossing and/or punching tools 700a-f have displaced the material of the sleeve blank in such a way that depressions have formed in which the material is tapered and can tear open when the spreading portion of the inner element is forced against the spreading zone during mounting. Again, the upper part of the drawing shows a plan view and the lower part shows a cross section along the line A-A.

One of the advantages of the described production method is that the spreading zone 630 is pressed onto the inner element, as a result of which an arrangement of the inner element within the sleeve is made possible. Due to the regions of the inner element with the different diameters, this results in an engagement of the spreading zone of the sleeve in the region between the drilling portion 670 and the spreading portion of the inner element (cf. depression 160 in FIG. 1 (b)).

The person skilled in the art will understand that the holding portion 640 can likewise be formed by embossing and/or punching tools. This can take place before, after or simultaneously with formation of the spreading zone. Alternatively, the holding portion 640 can be formed before or after formation of the spreading zone via a machining process.

The above description contains exemplary embodiments of one or more embodiments of the invention. Of course, it is not possible to describe every conceivable combination of the components and methods according to the invention in the abovementioned exemplary embodiments. Rather, a person skilled in the art will appreciate that there are numerous further combinations of further embodiments. Correspondingly, the exemplary embodiments described are intended to comprise all these further combinations, modifications, variations and embodiments which fall within the scope of the appended claims.

1. A fastening system for mounting at a substrate, the fastening system comprising a sleeve and an inner element,
wherein the sleeve comprises a holding portion, a spreading zone as well as a drill opening at one of the two ends of the sleeve and a tool opening at the other end, wherein the spreading zone is arranged at least partially between the holding portion and the drill opening, and
wherein the inner element is arranged at least partially within the sleeve and is movable relative to the sleeve, and
wherein the inner element comprises a drilling portion and a spreading portion, wherein the drilling portion comprises at least one cutting element and the drilling portion projects at least partially out of the drill opening of the sleeve and the spreading portion of the inner element is adapted to spread the spreading zone of the sleeve upon a movement of the spreading portion in the sleeve and relative to the sleeve in the direction from the tool opening to the drill opening.

2. The fastening system according to claim 1, wherein the spreading zone of the sleeve comprises a first outer diameter in the unspread state and the drilling portion of the inner element comprises a maximum second outer diameter and wherein the maximum second outer diameter and the first outer diameter are of equal size or the maximum second outer diameter is larger than the first outer diameter.

3. The fastening system according to claim 1, wherein the spreading portion of the inner element is conically shaped.

4. The fastening system according to claim 1, wherein the inner element is formed at least partially from a metal.

5. The fastening system according to claim 4, wherein the drilling portion of the inner element is formed at least partially from a metal.

6. The fastening system according to claim 1, wherein the sleeve is formed at least partially from a metal or a plastic.

7. The fastening system according to claim 1, wherein at least a portion of the holding portion of the sleeve is formed as one of:
a circumferential projection,
a holding plate for holding insulating material, or
a conical portion.

8. The fastening system according to claim 1, wherein the inner element comprises a receptacle for a setting tool.

9. A method for mounting a fastening system at a substrate, the fastening system comprising a sleeve and an inner element,
wherein the sleeve comprises a holding portion, a spreading zone as well as a drill opening at one of the two ends of the sleeve and a tool opening at the other end, wherein the spreading zone is arranged at least partially between the holding portion and the drill opening, and
wherein the inner element is arranged at least partially within the sleeve and is movable relative to the sleeve, and
wherein the inner element comprises a drilling portion and a spreading portion, wherein the drilling portion comprises at least one cutting element and the drilling portion projects at least partially out of the drill opening of the sleeve; and
wherein the method comprises the steps of:
driving the inner element into the substrate and simultaneously carrying the sleeve along with the movement of the inner element until the holding portion of the sleeve opposes a force to further carry the sleeve along; and
further driving the inner element into the substrate, whereby a relative movement is generated between the inner element and the sleeve, and simultaneously spreading the spreading zone of the sleeve with the spreading portion of the inner element by the relative movement.

10. A method for manufacturing a fastening system for mounting at a substrate, the method comprising:
providing a plurality of embossing and/or punching tools;
providing a sleeve blank, the sleeve blank having a substantially cylindrical shape;
providing an inner element, wherein the inner element comprises a drilling portion and a spreading portion and wherein the drilling portion comprises at least one cutting element arranged thereon;
placing the first end of the inner element in the sleeve blank;
circumferentially pressing at least a portion of the sleeve blank onto the inner element and thereby forming a spreading zone in the pressed portion and generating at least one predetermined separation point in the spreading zone formed by the pressing using at least one embossing or punching tool.
